(19) United States
(12) Patent Application Publication
(10) Pub. No.: US 2013/0216641 A1
(43) Pub. Date: Aug. 22, 2013

(54) MOLD ROLLER AND METHOD OF MANUFACTURING SUCH

(71) Applicant: CHIA-LING HSU, Tu-Cheng (TW)

(72) Inventor: CHIA-LING HSU, Tu-Cheng (TW)

(21) Appl. No.: 13/646,746

(22) Filed: Oct. 8, 2012

(30) Foreign Application Priority Data
Feb. 22, 2012 (TW) 101105758

(51) Int. Cl. B29C 59/04; B32B 37/00; B32B 38/10

(52) U.S. Cl. 425/363; 156/322; 156/257

(57) ABSTRACT

A mold roller and a method of manufacturing the mold roller comprising heating a metal substrate which has a microstructure pattern and attaching an ethylene tetrafluoroethylene (ETFE) film on the heated metal substrate. The ETFE film is pressed on the heated metal substrate and the microstructure pattern is thereby transferred and formed on a first side of the ETFE film The FIFE film with the microstructure pattern is than transferred to a circumferential surface of a core roller by a roller-to-roller process as its second side opposite to the first side attached to the circumferential surface.

### BACKGROUND

1. Technical Field

The present disclosure relates to a mold roller and a method of manufacturing the mold roller, more particularly to a mold roller haying an ethylene tetrafluoroethylene (ETFE) film formed with a microstructure pattern.

2. Description of Related Art

To manufacture optical films of backlight modules, a roller curved with pattern is used to imprint a microstructure pattern onto the films coated with ultraviolet (UV) curable ink. However, UV curable ink stays on a circumferential surface of the roller, and dust falls onto the circumferential surface of the roller, wherein such residual UV curable link and dust will decrease the life-span. of the roller. Otherwise, the rollers are usually made of a material of metal, e.g. copper, which leads to high production cost and design limitations of pattern curved thereon.

Therefore, a nonmetallic roller mold which can overcome the above-mentioned problem is needed.

### BRIEF DESCRIPTION OF DRAWINGS

The components in the drawings are not necessarily drawn to scale, the emphasis instead being placed upon clearly illustrating the principles of a mold roller and a method of manufacturing the mold roller. Moreover, in the drawings, like reference numerals designate corresponding parts throughout the several views.

FIG. 1 is a schematic view of a mold roller in accordance with an exemplary embodiment of the present disclosure.

FIG. 2 is a flowchart of a method of manufacturing an LIFE film with a microstructure pattern in accordance with an exemplary embodiment of the present disclosure.

FIG. 3 is schematic view of a metal substrate for manufacturing the ETFE film in accordance with an exemplary embodiment of the present disclosure.

FIG. 4 is schematic view illustrating manufacturing the ETFE film accordance with an exemplary embodiment of the present disclosure.

FIG. 5 is schematic view illustrating manufacturing a mold roller in accordance with an exemplary embodiment of the present disclosure.

### DETAILED DESCRIPTION

For solving disadvantages brought with the conventional metal roller curved with pattern, the present disclosure pro ides a mold roller and a method of manufacturing such, while the mold roller has an ETFE film formed with a microstructure pattern. An exemplary embodiment of the present disclosure is illustrated below.

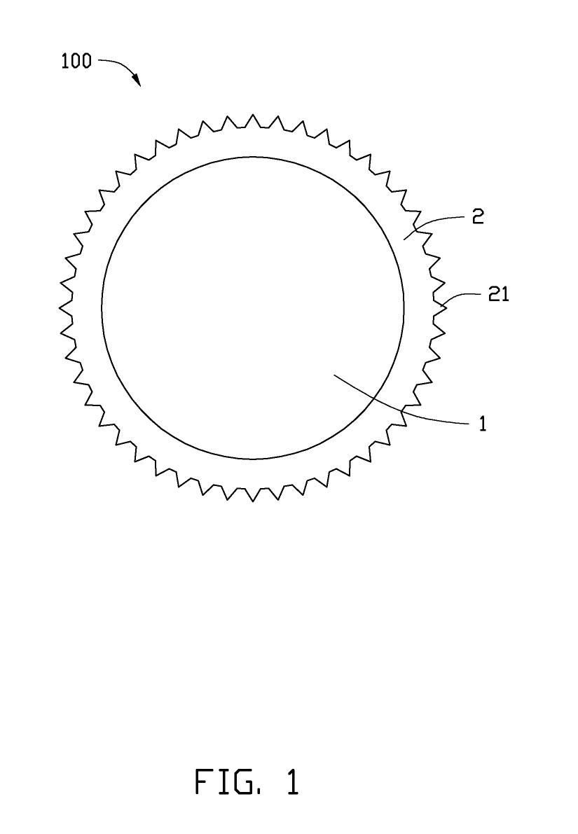

FIG. 1 shows a mold roller 100 of the exemplary embodiment of the present disclosure. The mold roller 100 includes a core roller 1 and an FIFE film 2 attached to a circumferential surface of the core roller 1. The ETFE film 2 has a microstructure 22 formed on a side opposite to attached side of the ETFE film 2

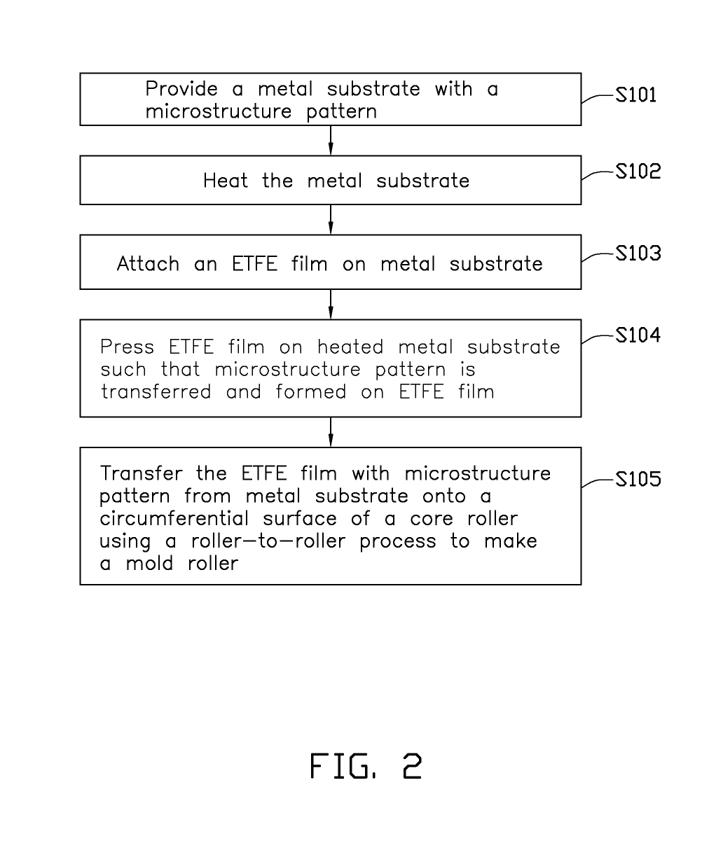

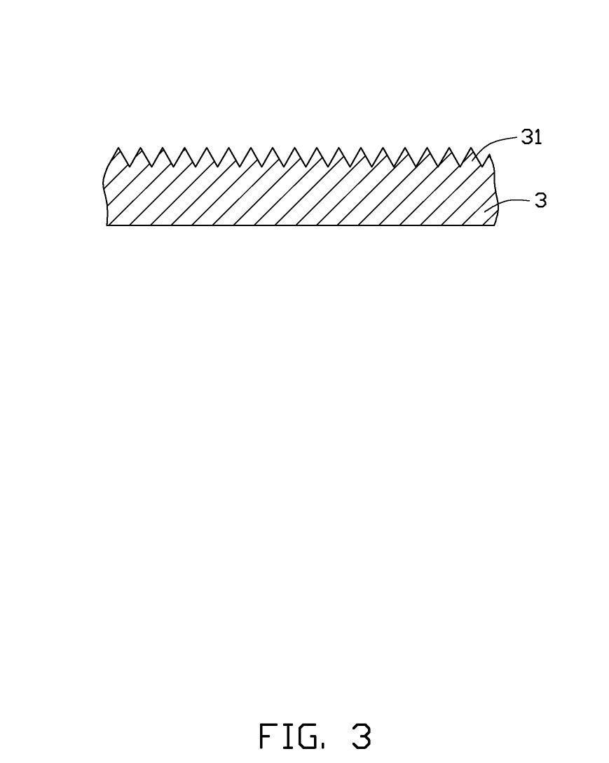

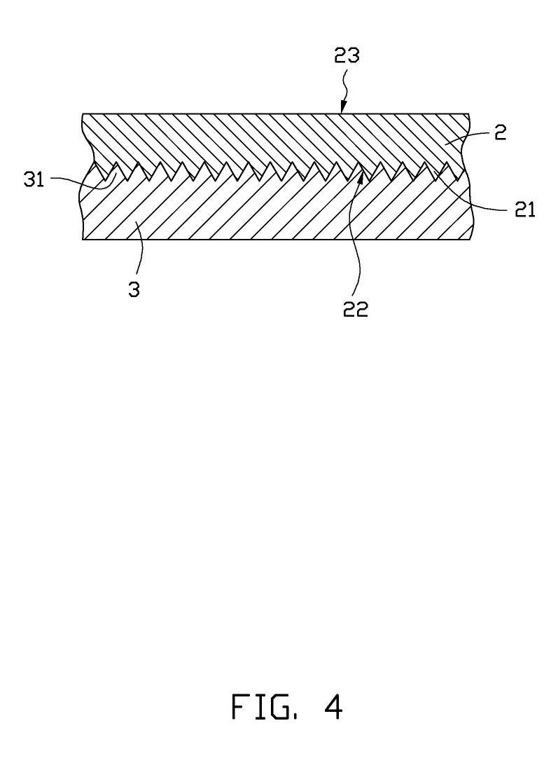

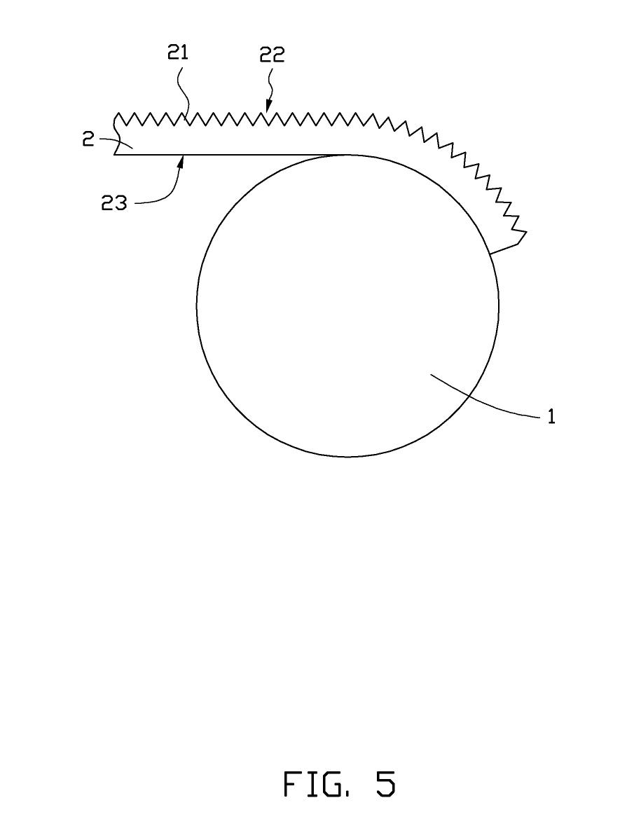

Referring to FIGS. 2-5, in step S101, a metal substrate 3 with a mold microstructure pattern 31 is provided. The mold microstructure pattern 31 is formed on the metal substrate 3 using a processes selected from a group consisting of laser cutting, diamond blade cutting or sand blasting.

In step S102, the metal substrate 3 is heated by a heat unit (not shown). The metal substrate 3 is heated to a range from 150° C. to 250° C. preferably heated to 200° C. In step S103, an FIFE film 2 having a first side 22 and an opposite second side 23 is attached on the metal substrate 3 by the first side 22. In step S104, the ETFE film 2 is pressed on the heated metal substrate 3, so the mold microstructure pattern 31 can be transferred and formed on the first side 22 of the FIFE film 2, as the microstructure pattern 21. Preferably, the film 21 is pressed onto the heated metal substrate 3 for about 5 minutes to 15 minutes.

In step S105, the ETFE film 2 with the microstructure pattern 21 is transferred from the metal substrate 3 onto a circumferential surface of a core roller 1 using a roller-to-roller process. The core roller 1 may be a metal roller. First, the FIFE film 2 is cut to a dimension corresponding to a dimension of the circumferential surface of the core roller 1. Than the second side 23 of the ETFE film 2 is adhesive to the circumferential surface of the core roller 1. As so, the mold roller 100 as shown in FIG. 1 has been produced.

The type of microstructure pattern 21 of the mold roller 100 can be easily changed since the FIFE film 2 can be easily manufactured and replaced. Furthermore, the ETFE film 2 has rare limitation in designing.

Although the present disclosure has been specifically described on the basis of this exemplary embodiment, the disclosure is not to be construed as being limited thereto. Various changes or modifications may be made to the embodiment without departing from the scope and spirit of the disclosure.

What the claim is:

1. A method of manufacturing a mold roller, comprising;
providing a metal substrate having a microstructure pattern;
heating the metal substrate;
attaching an ethylene tetrafluoroethylene (ETFE) film on the metal substrate;
pressing the ETFE film on the heated metal substrate such that the microstructure pattern is transferred and formed on the ETFE film; and
transferring the ETFE film with the microstructure pattern from the metal substrate onto a circumferential surface of a core roller, using a roll-to-roll process.

2. The method according to claim 1, wherein the microstructure pattern is formed on the metal substrate using a process selected from a group consisting of laser cutting, diamond blade cutting and sand blasting.

3. The method according to claim 1, wherein the metal substrate is heated to a range from 150° C. to 250° C. and the ETFE film is pressed onto the heated metal substrate for a time period of 5 to 15 minutes.

4. A mold roller comprising:
a core roller, and
an FIFE film attached on a circumferential surface of the core roller, the ETFE film having a first side and an opposite second side, a microstructure pattern formed on the first side, the second side being attached to the circumferential surface of the core roller.
